(19) United States
(12) Patent Application Publication
(10) Pub. No.: US 2023/0334586 A1
(43) Pub. Date: Oct. 19, 2023

(54) Remote Real Property Inspection

(71) Applicant: Tractable Ltd, London (GB)

(72) Inventors: Giacomo MARIOTTI, London (GB); David PRIBIL, London (GB); Thomas ROGERS, London (GB)

(21) Appl. No.: 18/303,023

(22) Filed: Apr. 19, 2023

Related U.S. Application Data
(60) Provisional application No. 63/363,193, filed on Apr. 19, 2022.

(51) Int. Cl. G06Q 40/08; G06V 20/52; G06V 20/10; G06V 20/20; G06V 10/25; G06V 10/70; G06T 7/00; G06T 7/11; G06T 17/00; G06T 19/00; G06Q 10/20; G06Q 30/0283; G01W 1/10

(52) U.S. Cl. CPC G06Q 40/08; G06V 20/52; G06V 20/10; G06V 20/20; G06V 10/25; G06V 10/70; G06T 7/0002; G06T 7/11; G06T 17/00; G06T 19/006; G06Q 10/20; G06Q 30/0283; G01W 1/10; G06T 2207/10032; G06T 2207/20081; G06T 2207/20104

(57) ABSTRACT

A system is configured to receive image data, identify, using a first set of one or more machine learning models, multiple objects related to real property that are shown in the image data, determine a number of unique objects that are shown in the image data and generate, using a second set of one or more machine learning models, an assessment of a state of the real property.

### PRIORITY/INCORPORATION BY REFERENCE

This application claims priority to U.S. Provisional Application Ser. No. 63/363,193 filed on Apr. 19, 2022 and entitled, “Remote Real Property Inspection,” the entirety of which is incorporated herein by reference.

### BACKGROUND

An artificial intelligence (AI) system may perform an inspection of real property by utilizing computer vision and other machine learning techniques to autonomously assess the state of the real property. An entity may utilize this type of AI system to provide any of a variety of different types of services. To provide an example, the state of the real property may be evaluated by the AI system to produce an estimated repair cost without involving a professional claims adjuster. In another example, the state of the real property may be evaluated by the AI system to appraise the real property without involving a professional appraiser. Other use cases where the state of real property is desired to be evaluated such as, but not limited to, rental property management, insurance underwriting and the processing of insurance claims may also utilize this type of AI system.

The entity may release a user facing application to provide the types of services referenced above. A user may capture images and/or videos of the real property using their mobile device. The images and videos may be input into the AI system to assess the state of the real property. However, if the images and videos do not adequately capture the objects of interest or are not of sufficient quality, the AI system may be unable to assess the state of the real property.

The user experience associated with the application is an important factor in attracting and retaining users. Each interaction between the user and the application is a potential point of friction that may dissuade a user from completing the inspection process and/or utilizing the application in the future. For example, the user may decide to not utilize the application if it is too inconvenient or difficult for the user to capture the image data that is to be used by the AI system to assess the state of the real property. Accordingly, there is a need for mechanisms that are configured to collect adequate data for the AI system to assess the state of the real property without negatively impacting the user experience associated with the application.

### SUMMARY

Some exemplary embodiments are related to a method for receiving image data, identifying, using a first set of one or more machine learning models, multiple objects related to real property that are shown in the image data, determining a number of unique objects that are shown in the image data and generating, using a second set of one or more machine learning models, an assessment of a state of the real property.

Other exemplary embodiments are related to a system having a memory storing image data and one or more processors identifying, using a first set of one or more machine learning models, multiple objects related to real property that are shown in the image data, determining a number of unique objects that are shown in the image data and generating, using a second set of one or more machine learning models, an assessment of a state of the real property.

### BRIEF DESCRIPTION OF THE DRAWINGS

FIG. 1 shows an exemplary user device according to various exemplary embodiments.

FIG. 2 shows an exemplary system according to various exemplary embodiments.

FIG. 3 shows a method for performing an assessment of real property using artificial intelligence (AI) according to various exemplary embodiments.

FIG. 4 shows a method for collecting image data to perform an inspection of real property using an AI based application according to various exemplary embodiments.

### DETAILED DESCRIPTION

The exemplary embodiments may be further understood with reference to the following description and the related appended drawings, wherein like elements are provided with the same reference numerals. The exemplary embodiments introduce systems and methods for assessing the state of real property using artificial intelligence (AI). As will be described in more detail below, computer vision and other types of machine learning techniques may be used to autonomously assess the state of real property (e.g., homes, buildings, fences, landscaping, etc.).

The exemplary embodiments are described with regard to an application running on a user device. However, reference to the term “user device” is merely provided for illustrative purposes. The exemplary embodiments may be used with any electronic component that is equipped with the hardware, software and/or firmware configured to communicate with a network and collect image and video data, e.g., mobile phones, tablet computers, smartphones, etc. Therefore, the user device as described herein is used to represent any suitable electronic device.

Furthermore, throughout this description, it may be described that certain operations are performed by one or more machine learning models or a series of machine learning models. Those skilled in the art will understand that there are many different types of machine learning models. For example, the exemplary machine learning models described herein may include visual and non-visual algorithms. Furthermore, the exemplary machine learning models may include classifiers and/or regression models. Those skilled in the art will understand that, in general, a classifier model may be used to determine a probability that a particular outcome will occur (e.g., an 80% chance that a part of a house (e.g., a wooden floor) should be replaced rather than repaired). While a regression model may provide a value (e.g., repairing the floor will require 20 labor hours). Other examples of machine learning models may include multitask learning models (MTL) that can perform both classification, regression and other tasks. The resulting AI system described below may include some or all of the above machine learning components or any other type of machine learning model that may be applied to determine the expected outcome of the AI system. It should be understood that any reference to one or more (or a series) of machine learning models may refer to a single machine learning model or a group of machine learning models. In addition, it should also be understood that the machine learning models described as performing different operations may be the same machine learning model or different machine learning models.

In addition, the exemplary embodiments are described with reference to real property. The user device may capture images and/or video of the real property for the purpose of assessing the state of the real property. However, it should be understood that the exemplary embodiments are not limited to assessing a state of any particular type of object related to real property. The exemplary embodiments may be implemented for any tangible object related to any aspect of real property for which a value or a condition may be evaluated. To provide some non-limiting examples, the exemplary embodiments may be used to assess the state of houses, buildings, rooms, fences, walkways, driveways, lawns, shrubs, trees, gardens, crops, sprinkler systems, lighting equipment, renewable energy equipment, and other objects associated with the real property, etc.

In some exemplary embodiments, it may be described that the AI may make evaluations by comparing images of damaged property versus images of undamaged property. However, it should be understood that the exemplary embodiments do not require such a comparison. In other exemplary embodiments, the AI may make evaluations without directly comparing an image of damaged property with images of undamaged property. That is, the machine learning models described herein may perform property evaluations for damaged property without regard to images of the undamaged property.

An entity may utilize AI to assess the state of real property and provide any of a variety of different services. To provide one example, the state of one or more objects may be evaluated by the AI system to produce an estimated repair cost without involving a professional claims adjuster. In another example, the state of one or more objects may be evaluated by the AI system to appraise real property without involving a professional appraiser. However, the exemplary embodiments are not limited to the example use cases referenced above. The exemplary techniques described herein may be used in independently from one another, in conjunction with currently implemented AI systems, in conjunction with future implementations of AI systems or independently from other AI systems.

The AI system may process image data to assess the state of real property. Throughout this disclosure, the term “image data” should be understood to refer to data that is captured by a camera or any other appropriate type of image capture device. In some examples, the image data may include one or more digital photographs. In another example, the image data may include one or more segments of video data comprising multiple consecutive frames. The one or more segments may be part of a single continuous recording or multiple different video recordings. In addition, the video data may be augmented by individual frames or images separately captured at a different resolution, a different angle relative to an object or point of interest or a different compression algorithm (or no compression algorithm). In some exemplary embodiments, the machine learning models may identify key frames of a video. For example, the machine learning model may determine that an object of interest is centered in the frame and whole object is in scene. In another example, the AI system may identify a maximal visual distance between frame captures of the same object to maximize information given to the machine learning models such as image variation under, for example, reflections/shadows, etc. In another example, the AI system may indicate when the perspective is optimal to provide accurate measurement of physical dimensions or where the object of interest has minimal occlusion by foreground objects. The image data may also include data not within the visible range for humans, such as infrared and ultraviolet data.

The user may collect image data using the camera of their user device. However, if the images and/or videos do not adequately capture the objects of interest or are not of sufficient quality, the AI system may be unable to assess the state of the real property from the image data. In this type of scenario, the user may be requested to provide additional images and/or videos. To ensure an adequate user experience, the process of collecting the images and videos needed by the AI system to assess the state of the real property should be an easy task for the user to complete.

In addition to the image data, the AI system may also utilize non-visual information (e.g., non-image information) including audio information, pressure and temperature information, moisture information, that may be collected by the user device 100. The user device 100 may be equipped with additional sensors to detect things such as the moisture or dampness of a ceiling, wall, floor, or floor covering (such as a rug or carpet). The audio information may include, for example, the sound of an item in the home operating (e.g., a furnace, air conditioner, sink, toilet, stove, etc.). Alternatively, the audio information may be information regarding the state of the real property recorded by a user, this information may be linked to a specific image or portion of a video.

Some of the exemplary mechanisms described herein are configured to reduce friction and improve the user experience associated with the application. For instance, in some examples, the user device may be configured to provide dynamic feedback to guide the user in collecting image data that adequately captures the objects of interest and is of sufficient quality to assess the state of the real property. The dynamic feedback makes the process of recording the video more intuitive and/or user-friendly. However, this is just one example of the various types of functionalities that may be enabled by the exemplary mechanisms introduced herein.

The AI system can collect and monitor data regarding the quality of data collection, the completion rate of the data collection process, and user satisfaction of the data collection process across multiple analyses of real properties. The AI system can be configured to automatically adjust the various parameters of the collection process to optimize any of the data selected by the users. Alternatively, the AI system can suggest to a human controller of the AI system and collection system to make alterations to the collection methodology.

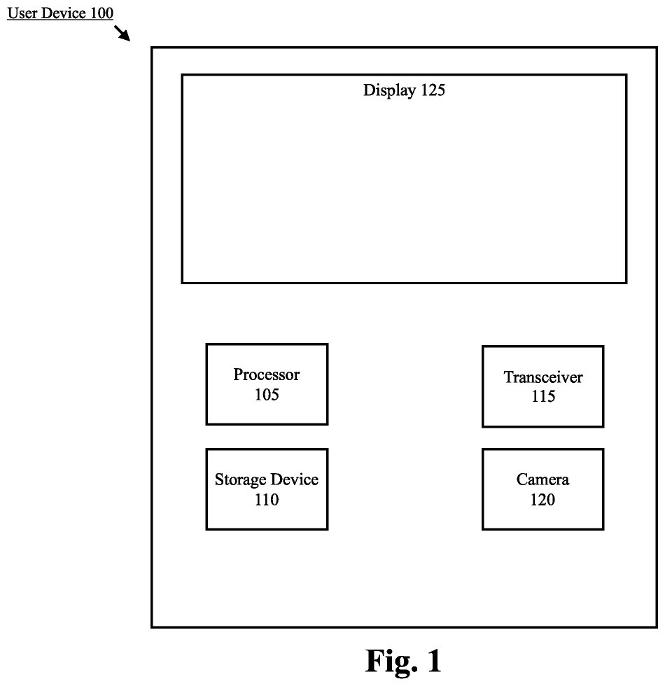

FIG. 1 shows an exemplary user device 100 according to various exemplary embodiments described herein. The user device 100 includes a processor 105 for executing the AI based application. The AI based application may, in one embodiment, be a web-based application hosted on a server and accessed over a network (e.g., a radio access network, a wireless location area network (WLAN), etc.) via a transceiver 115 or some other communications interface. In other embodiments, all of the AI based application may be stored and executed locally at the user device 100.

The above referenced application being executed by the processor 105 is only exemplary. The functionality associated with the application may also be represented as a separate incorporated component of the user device 100 or may be a modular component coupled to the user device 100, e.g., an integrated circuit with or without firmware. For example, the integrated circuit may include input circuitry to receive signals and processing circuitry to process the signals and other information. The AI based application may also be embodied as one application or multiple separate applications. In addition, in some user devices, the functionality described for the processor 105 is split among two or more processors. The exemplary embodiments may be implemented in any of these or other configurations of a user device.

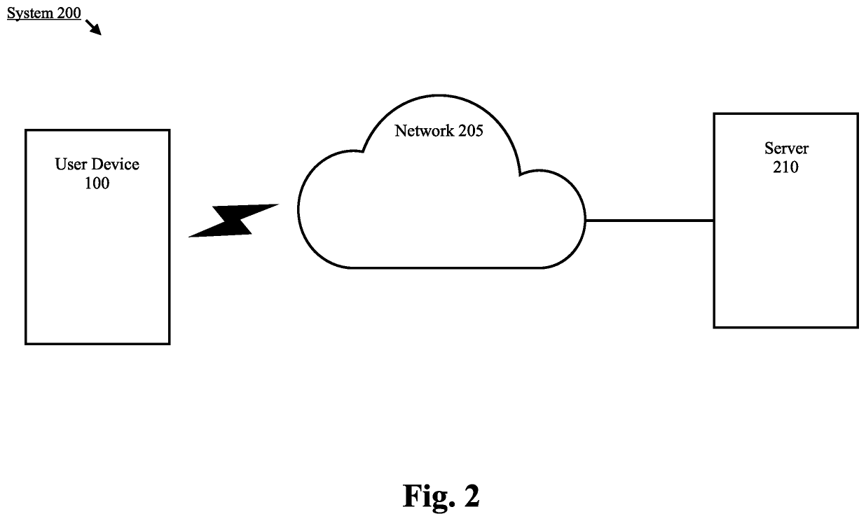

FIG. 2 shows an exemplary system 200 according to various exemplary embodiments. The system 200 includes the user device 100 in communication with a server 210 via a network 205. However, the exemplary embodiments are not limited to this type of arrangement. Reference to a single server 210 is merely provided for illustrative purposes, the exemplary embodiments may utilize any appropriate number of servers equipped with any appropriate number of processors. In addition, those skilled in the art will understand that some or all of the functionality described herein for the server 210 may be performed by one or more processors of a cloud network.

The server 210 may host a platform associated with the application. The platform may be a set of physical and virtual components configured to execute software to provide any of a variety of different services. The platform may manage stored data, interact with users (e.g., customers, employees, etc.) and perform any of a variety of different operations.

In one example, the user device 100 may store application software including, but not limited to, one or more machine learning models, locally at the user device 100. The application may utilize the one or more machine learning models or any other appropriate type of mechanism to assess the state of real property based on image data collected by the user device 100. The data collected and derived by the user device 100 may then be provided to the remote server 210 where, optionally, additional operations may be performed. In another example, the user device 100 may collect image data and provide it to the server 210. The server 210 may utilize one or more machine learning models or any other appropriate type of mechanism to assess the state of real property based on images and/or video of the real property.

The user device 100 further includes a camera 120 for capturing video and a display 125 for displaying the application interface and/or the video with a dynamic overlay. Additional details regarding the dynamic overlay are provided below. The user device 100 may be any device that has the hardware and/or software to perform the functions described herein. In one example, the user device 100 may be a smartphone with the camera 120 located on a side (e.g., back) of the user device 100 opposite the side (e.g., front) on which the display 125 is located. The display 125 may be, for example, a touch screen for receiving user inputs in addition to displaying the images and/or other information via the web-based application.

In the example of FIG. 2, it is shown that there may be an interaction between the user device 100 and the server 210. However, it should be understood that information from the user device 100 and/or server 210 may be distributed to other components via the network 205 or any other network. These other components may be components of the entity that operates the server 210 or may be components operated by third parties. Examples of the third parties are provided throughout this description and may include, for example, insurance companies, contractors, governmental agencies, aid or relief organizations, etc. That is, the results of the evaluations may be made available to any entity that is authorized by the owner of the property and/or the operator of the server 210 to receive the results.

The examples provided below reference one or more machine learning models (e.g., classifiers) performing operations such as, but not limited to, identifying objects shown in the image data, identifying damaged objects shown in the image data, determining a state for an one or more objects shown in the image data, determining dimensions of one or more objects shown in the image data and determining the materials of one or more objects shown in the image data. Each classifier may be comprised of one or more trained models. The classifying AI may be based on the use of one or more of: a non-linear hierarchical algorithm, a neural network, a convolutional neural network, a recurrent neural network, a long short-term memory network, a multi-dimensional convolutional network, a memory network, a transformer network, a fully convolutional network, a gated recurrent network, gradient boosting techniques, random forest techniques.

Generally, machine learning models may be designed to progressively learn as more data is received and processed. Thus, the exemplary application described herein may periodically send its results to a centralized server so as to refine the model for future assessment.

In some embodiments, a single machine learning model (e.g., classifier) may be stored locally at the user device 100. This may allow the application to produce quick results even when the user device 100 does not have an available connection to the Internet (or any other appropriate type of data network). This machine learning model may be configured to generate multiple different types of outputs. The use of a single machine learning model trained to perform multiple tasks may be beneficial to the user device 100 because it may take up significantly less storage space compared to multiple machine learning models that are each specific to a different task. Thus, the machine learning model described herein is sufficiently compact to run on the user device 100, and may include multi-task learning so that one classifier and/or model may perform multiple tasks. However, the exemplary embodiments are not limited to the user device 100 being equipped with a single machine learning model. For instance, the user device 100 may be equipped with one or more machine learning models that are dedicated to a single task (e.g., identifying objects, identifying damages, determining dimensions, determining materials, etc.). Any appropriate number of machine learning models may be stored and/or utilized by the user device 100.

In addition, for the embodiments discussed below, the evaluations may be performed at a user device, a server or a combination thereof. In instances where an entity other than the homeowner is the intended recipient of the information, it is more likely that the evaluations will be performed by a server. For example, in situations where the intended user is concerned about the impacts to all or a subset of structures in a region, the application will be running on a server or set of servers running multiple machine learning models.

In other embodiments, one or more machine learning models may be stored in a cloud network. The user device 100 may collect image data and upload it to the cloud network for processing by one or more machine learning models. The output of the one or more machine learning models may be provided to the user device 100 and/or stored for future use. Some of the machine learning models may include multi-task learning as to enable the performance of multiple tasks by a single machine learning model. In some embodiments, the cloud may be configured with a one or more machine learning models that are each dedicated to a single task (e.g., identifying objects, identifying damages, determining dimensions, determining materials, etc.). However, the exemplary embodiments are not limited to the examples provided above and may be implemented using any appropriate arrangement of devices and machine learning models.

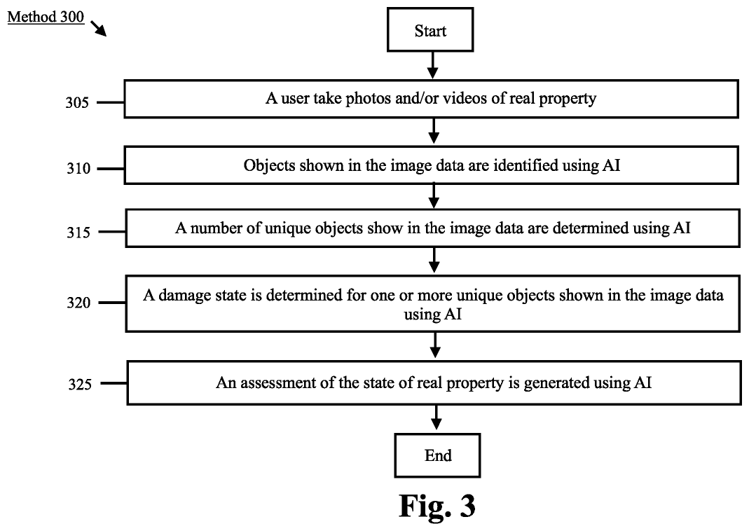

FIG. 3 shows a method 300 for performing an assessment of real property using AI according to various exemplary embodiments. The method 300 provides a general overview of how image data may be used to assess the state of real property. In addition, various exemplary use cases are described within the context of the method 300.

The image data may include photos and/or videos taken by a user with the camera 120 of the user device 100. The photos and/or videos may be augmented by individual images or frames separately captured at a different resolution, a different angle relative to an object or point of interest or a different compression algorithm (or no compression algorithm). In some embodiments, the image data may further include photos and/or videos taken by a device other than the user device 100. For example, in some use cases, satellite images, images taken by a drone or images taken during an aerial fly over may also be utilized to assess the state of the real property.

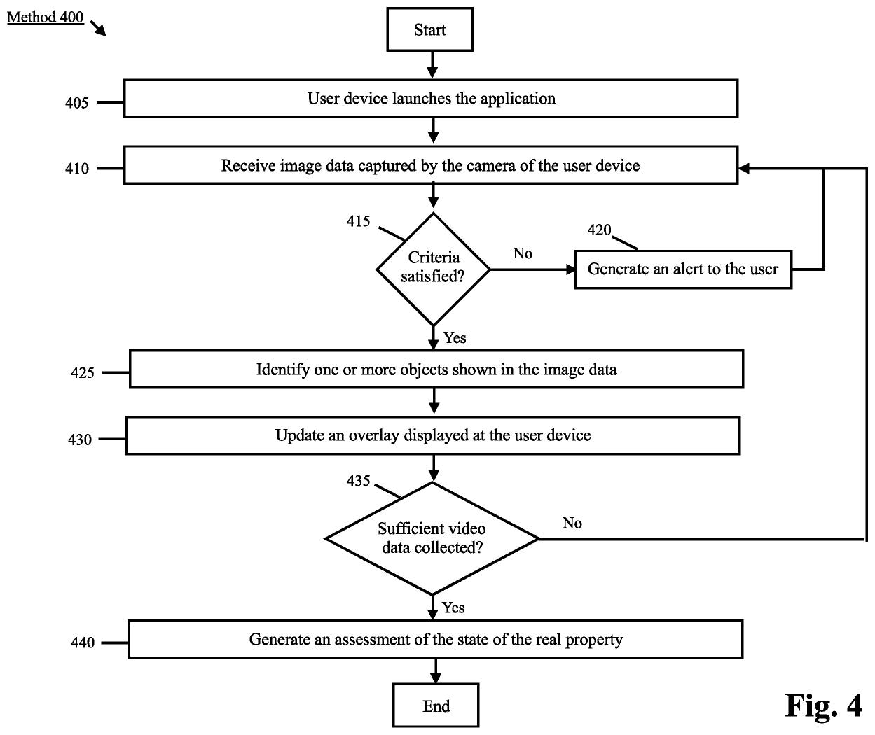

According to some aspects, the exemplary embodiments introduce techniques for providing dynamic feedback that is to guide the user in taking photos and/or video that are sufficient for assessing the state of the real property. In some embodiments, this information may be provided to the user while the user is actively utilizing the camera 120 to take the photos and/or videos of the real property to be assessed. During the description of the method 300, examples may reference exemplary techniques for providing instructions and dynamic feedback to the user that is to guide the user in collecting adequate image data. A more comprehensive description of the exemplary dynamic feedback mechanisms is provided below with regard to the method 400 of FIG. 4.

Throughout this description it should be understood that any of the photos/images/videos may be augmented using, for example, augmented reality (AR) techniques, virtual reality (VR) techniques, three-dimensional (3D) data such as point clouds, etc. For example, the application being executed on the user device 100 may include functionality that allows these techniques to be incorporated into the image collection. To provide some specific but non-limiting examples, the application may, using AR techniques, present the user with a view of the property prior to the damage when collecting photos or video. For example, the user may collect images of the property prior to the damage that may be used by the AR functionality to show the user what the property looked like prior to the damage so the user collects photos/video that shows all the damage by comparing the current damaged state of the property to the previous non-damaged state of the property. In another example, the AR functionality may be used to measure precise coordinates of a location (e.g., the corners of a room) or other objects. This may allow the application (or the AI system) to understand the scene and damage in 3D.

Some of the exemplary use cases generally relate to assessing the state of real property after the occurrence of an event that may have caused damage to one or more objects. For example, the event may be a storm, a flood, a fire, a termite infestation, a construction accident or any other type of event that may cause damage to one or more objects associated with real property. Thus, the assessment of the real property may be used to provide services related to insurance claims such as, but not limited to, initial repair cost estimates, determining whether an in-person inspection is needed and determining whether a home habitable. Other exemplary use cases relate to services such as, but not limited to, insurance underwriting, appraising a sale value, managing a rental property, tracking a state of the real property overtime and identifying improvements that may increase the value of the real property. The above examples are not intended to limit the exemplary embodiments in any way. Instead, these examples are intended to provide some context as to how the exemplary assessment of real property may be utilized to provide various different types of services.

In 305, a user takes photos and/or videos of real property. For example, a user may take the photos and/or videos with the camera 120 of the user device 100. As will be described in more detail below with regard to the method 400, in some embodiments, the photos and/or videos may be evaluated for quality and clarity prior to being utilized for the method 300.

The photos and/or videos may each depict multiple objects related to real property. Throughout this description, the term “object” may be used to refer to any tangible thing in the real world comprised of one or more parts. In some examples, a part of an object may also be referred to as an object. For instance, the term object may be used to refer to a building as a whole but is may also be used to refer to a window of the building. Thus, any example that characterizes a particular thing as an object is merely provided for illustrative purposes. The exemplary embodiments are not limited to any particular type of objects related to real property.

To provide some non-limiting examples, within the context of the exterior of a residential house, relevant objects may include, but are not limited to, exterior walls, windows, doors, screens, roofs, sky lights, gutters, fences, shrubs, trees, crops, gardens, yards, parking lots, driveways, walkways, garages, sheds, stairs, patios, decks, outdoor furniture, lighting equipment, electrical equipment, renewable energy equipment and sprinklers. Within the context of the interior or a residential house, the objects may include but are not limited to, interior walls, ceilings, floors, lighting fixtures, windows, screens, blinds, curtains, doors, furniture, appliances, electronics, electrical equipment and exercise equipment. However, the examples provided above are merely provided for illustrative purposes and are not intended to limit the exemplary embodiments in any way.

In the method 300, examples are provided where operations are performed by “one or more machine learning models.” As mentioned above, in some embodiments, a single machine learning model may be configured to perform multiple different tasks. In other embodiments, a single machine learning model may be dedicated to a specific task. Accordingly, reference to one or more machine learning models may represent any appropriate number of machine learning models configured to perform any appropriate number of operations.

In some embodiments, the machine learning models may be agnostic with respect to the type of architecture, manufacturer, model and/or style of the objects to be assessed. That is, the user may not be required to manually provide any identifying information about an object to be assessed to enable the machine learning models to focus its calculations based on known properties of the object. Instead, a user may simply open the application and begin capturing images or videos of the objects of interest without entering any initial information with respect to the type of object, type of architecture, manufacturer, model or style. In other embodiments, a type of object to be assessed may be specified (e.g., house, window, fence, etc.), or some other information may be obtained from the user to determine which machine learning model is to be utilized.

In addition to the image data, information related to the real property and/or customer may also be manually entered by the user or retrieved from a source remote to the user device 100. This information may be provided before, during or after the image data is collected. The information may include but is not limited to, a customer identity, a request for a type of service (e.g., insurance claim, appraisal, insurance underwriting, etc.), an indication of the type of objects to be assessed, an indicated of the number of unique objects to be assessed and parameters or characteristics of the objects to be assessed. In some embodiments, the application may request that the user provide additional information or image data for the real property and/or customer based on an analysis of the image data collected in 310. However, the exemplary embodiments may be utilized in a wide variety of different types of use cases and the image data, real property information and/or customer information may be provided by a user in any appropriate manner and include any appropriate type of information that may be utilized to assess the state of real property.

In some examples, each of the one or more machine learning models may receive the same input data (e.g., image data collected by the user device 100, image data collected by another source, customer information, real property information, region specific information, etc.). In other examples, different machine learning models may receive different input data. For instance, a first set of image data may be provided to one machine learning model and a second different set of image data may be provided to another machine learning model or the output of a first machine learning model may be included as part of the input data provided to a second machine learning model.

In 310, objects shown in the image data are identified using AI. To provide a general example, consider a scenario in which the photos and/or videos show the exterior of a house from multiple locations around the perimeter of the house. The image data may be input into one or more machine learning models configured to identify different types of objects, e.g., a house, exterior walls, windows, doors, gutters, etc. When identifying objects in the image data, the one or more machine learning models may determine a location of one object relative to another object, light source and/or coordinate.

In some embodiments, multiple machine learning models (e.g., classifiers) may be used where each machine learning model is trained to identify one or more specific types of objects related to real property. Each machine learning model may receive all of the available image data or each machine learning model may receive a subset of the image data determined to be relevant to the respective machine learning model. In other embodiments, a single machine learning model may be used to perform the identifying in 310 or, as mentioned above, a single machine learning model may perform all of the operations needed to generate the assessment of the state of real property (e.g., 325).

In 315, a number of unique objects shown in the image data is determined using AI. Each instance of real property may be comprised of an arbitrary number of objects. Continuing with the example provided above, the exterior of a house may include multiple exterior walls, multiple windows, multiple doors and multiple sections of gutters. Thus, the image data may include multiple photos and/or videos that each show the same object. To ensure that each unique object shown in the image data is only accounted for a single time, computer vision techniques may be used to count and track each unique object shown in the image data.

In 320, a damage state is determined for one or more unique objects shown in the image data using AI. For example, the image data may be input into one or more machine learning models configured to determine whether an object is damaged. In some embodiments, a damage state may be determined for each unique object shown in the image data. In other embodiments, only a subset of the unique objects shown in the image data may be evaluated for damage. When determining the damage state, the one or more machine learning models may also determine a degree of damage to an object, a location of the damage relative to the object, possible repair methodologies including whether an object should be repaired or replaced, a number of labor hours that may be involved in the repair and an estimated cost of repair. The total estimated cost of repair may include, for example, costs including labor costs, material costs, part costs, scaffolding costs, disposal costs, permitting costs, and other costs associated with the repair.

In 325, an assessment of the state of the real property is generated using AI. In some embodiments, a machine learning model may output an assessment of the real property as a whole. In other embodiments, the assessment of the real property as a whole may be derived based on the output of multiple machine learning models. The contents of the assessment may vary depending on the use case, examples of which are provided in detail below.

The one or more machine learning models may also be trained to determine the physical real world dimensions of a unique object. For example, one or more machine learning models may determine the height and width of a window or a door, the height and length of one or more sections of fence, the dimensions of a house or the area of a room. The dimensions of the unique objects may be used in determining the damage state, performing the assessment in 325 or for any other appropriate purposes related to assessing the state of real property. In addition, the one or more machine learning models may be trained to determine the materials that make up a unique object. For example, one or more classifiers may determine that a fence is made of polyvinyl chloride (PVC), vinyl, pavers, cinder blocks or chain link. In another example, one or more machine learning models may determine that a floor is carpeted, tiled or hard wood. In a further example, one or more machine learning models may determine that an exterior wall is constructed of brink, wood, aluminum siding, cedar shingles or vinyl. The material composition of the unique objects may be used in determining the damage state, performing the assessment in 325 or for any other appropriate purposes related to assessing the state of real property.

In some embodiments, multiple machine learning models may be used where a first set of one or more machine learning models may be trained to perform the identifying in 310, a second set of one or more machine learning models may be trained to determine the damage state in 320 and a third set of one or more machine learning models may be trained to perform the assessment in 325. In other embodiments, a single machine learning model may be used to perform multiple tasks or, as mentioned above, a single machine learning model may perform all of the operations to generate the assessment of the state of real property (e.g., 325).

Prior to or during the method 300, image segmentation may be performed on one or more images or frames of video to identify segments of interest or to segment objects of interest. In some exemplary embodiments, the image segmentation may be used to identify objects that are blocking a view of an object of interest (such as a lamp blocking the view of a portion of interest of a wall, or a bag blocking the view of a table). This information may be used in a variety of manners. In one example, the information may be used to request the user to move the blocking object and take a new image. In another example, the application and/or AI system may remove the blocking object from the image using, for example, AR or VR techniques. The segmentation performed on the image data may be used by the one or more machine learning models to better identify otherwise difficult to detect objects and/or damage. Thus, in some embodiments, the image data may further include multiple sets of image segments where each set of image segments may be generated from a single image or video. However, the exemplary embodiments are not required to use image segmentation. Any appropriate computer vision techniques may be utilized to assist the machine learning models in performing their configured task on the image data.

In some embodiments, the application running on the user device 100 may perform the assessment of the state of the real property. This assessment may then be sent to the server 210 or any other appropriate remote location for future use by the entity. For example, the application may display an initial estimated repair cost at the user device 100 and then provide the data collected and derived at the user device 100 (e.g., the image data, the information manually entered by the user, the estimated repair cost) to the server 210. Subsequently, any of a variety of different services may be provided by the entity using the data collected and/or derived at the user device 100. In other embodiments, the user device 100 may collect the image data and then provide it to the server 210 where the assessment is performed. The assessment may then be provided to the customer via the user device 100 or in any other appropriate manner. In either scenario, the data collected and/or derived by the user device 100 may be utilized by the entity to provide any of a variety of different services.

In one exemplary use case, the application may be used to provide a full or partial initial estimate to repair damaged objects after the occurrence of an event. To provide an example, within the context of the method 300, consider a scenario in which an event has caused damaged to the exterior of a residential home. The user takes photos and/or videos of the exterior of the home from various point along the perimeter of the home using the camera 120 of the user device 100. The image data may be input into one or more machine learning models and an assessment of the state of the real property (e.g., 325) may be provided at the user device 100.

In some embodiments, the assessment may identify a number of damaged objects and provide an estimated repair cost. For example, after a storm, the machine learning models may identify that two out of ten windows were broken and the estimated cost to replace the broken glass. In addition to the image data, the estimate may be based on operations performed by the machine learning models such as, but not limited to, determining the dimensions of the glass to be replaced and determining an estimated number of labor hours to replace the broken glass. In another example, the machine learning models may identify that a section of fence has been broken and the estimate cost to replace the section of broken fence. In addition to the image data, the estimate may be based on operations performed by the machine learning models such as, but not limited to, determining the material of the fence, the dimensions of the section of fence to be replace and an estimated number of labor hours to replace the broken glass.

To provide another example, within the context of the method 300, consider a scenario in which an event has caused damaged to the interior of a residential home. The user takes photos and/or videos of the interior of the home using the camera 120 of the user device 100. The image data may be input into one or more machine learning models and an assessment of the state of the real property (e.g., 325) may be provided at the user device 100.

In some embodiments, the assessment may identify a number of damaged objects and provide an estimated repair cost. For example, after an event that causes water damage, the machine learning models may identify water damage to an interior wall, determine whether and/or how the wall can be repaired and an estimated cost to repair or replace the wall. In addition to the image data, the estimate may be based on operations performed by the machine learning models such as, but not limited to, identifying the materials of the wall, determining the dimensions of the walls and determining an estimated number of labor hours. In another example, the machine learning models may identify fire and/or smoke damage to one or more objects, the estimated cost to replace destroyed objects and the estimated cost to repair the damage. In addition to the image data, the estimate may be based on operations performed by the machine learning models such as, but not limited to, determining the material of the damaged objects, the dimensions of the damaged objects and an estimated number of labor hours to replace the damaged object and/or repair the damage.

Alternative assessments may be made, including, a recommendation of whether to file an insurance claim based on an estimated cost value exceeding a threshold cost value or an analysis of the impact of a claim on future insurance premiums compared to the cost of the repair. For example, it may not make any sense financially for the user to replace a single broken window if the claim is likely to cause the insurance premium to significantly increase. An additional assessment may include a recommendation as to whether a building is habitable in its current state, or whether the damage suffered by the building is sufficiently severe to preclude living or occupying the building prior to repair.

From the perspective of the entity providing the service, the assessment in 325 may indicate whether an in-person inspection is to be performed on the real property. This may allow the entity to more efficiently deploy their employees (e.g., inspectors, adjusters, etc.) when there is an in-flux of assessments in response to the occurrence of an event. For example, the entity may be able to quickly identify a customer who has a home that has been initially assessed to be inhabitable and deploy an inspector as soon as possible.

In some embodiments, aerial imaging may be used in addition to the image collected by the user device 100. For example, satellite images, image data captured by a drone or image data captured during a fly over the real property that depict the object of interest before and/or after an event may also be provided to the one or more machine learning models. This type of imaging may be used to assess the condition of the roof of the house, crops, landscaping, equipment, wiring, roads or any other aspect of real property that may be visible from the air.

The exemplary machine learning models may also consider characteristics of the event that caused the damage and determine whether the damage identified in the image data is consistent with the event. If the damage to an object is determined not to be consistent with the event or the cause of the damage, the damage may not be considered in the assessment 325. For example, a storm may knock down a tree that damages a section of fence. The fence also has sections of peeling paint or rust. The one or more machine learning models may determine that the damage caused by the tree was likely caused by a storm but the paint/rust damage was already likely to be present prior to the storm. Thus, the initial estimate of an insurance claim performed during the assessment 325 may not consider the cost of repairing damage that was determined to be inconsistent with the event.

In another exemplary use case, the application may be used to provide an initial appraisal without involving a professional appraiser. Compared to a damage estimate for an insurance claim, an accurate appraisal may need to consider damage of a lesser magnitude and other less visually obvious factors. For example, the real property being inspected may not been recently significantly impacted by any specific event (e.g., storm, flood, fire, accident, etc.) and thus, the image data may not show significant structural damage consistent with a natural disaster. However, factors such as, but not limited to, rust, paint condition (e.g., faded, peeling, flaking, bubbling, etc.) and surface condition may have an impact on the appraisal of the real property. It has been identified that, video data may allow the application to identify damage of a lesser magnitude and evaluate less obvious factors when assessing the state of the real property. While video data provides benefits to the use case of performing an initial appraisal of real property, the exemplary embodiments may utilize any appropriate type of image data, including infrared or ultraviolet image data. Additionally, the AI system may use other types of data alone, or in combination with image data, to identify damage, such as audio recordings of an object operation, an oral or text description of damage made at the same time of the image data, etc. Other examples of non-image data (e.g., temperature, moisture, etc.) were also provided above.

For this type of use case, the damage state determination (e.g., 320) and/or the assessment 325 may also include assessments of minor or cosmetic damage. These assessments could be used in non-repair situations, for example, to help in the appraisal of the home to determine a recommended listing price or for use in insurance underwriting. In another example, these assessments may be used to manage rental properties where the exemplary embodiments may be used to perform an assessment of the rental unit before, during and/or at the conclusion of the rental agreement. In some embodiments, the assessment may be utilized to initiate and/or terminate a smart contract. Thus, the minor damage assessments may be used, optionally along with other information of the real property, to determine the overall state of the real property.

In this type of use case, the assessment (e.g., 325) may include a paint condition or a surface condition for one or more unique objects. For example, the one or more machine learning models may identify a paint condition for a unique object. The paint condition may be output as a score or a preset identifier (e.g., faded, flaking, bubbling, scratched, satisfactory, mint, etc.). Similarly, the one or more machine learning models may identify a surface condition for a unique object, the surface condition may be output as a score or a preset identifier (e.g., faded, chipped, cracked, scratched, weathered, satisfactory, mint, etc.). In addition, the assessment may include a rust condition for one or more unique objects. For example, the one or more machine learning models may identify for each unique object a severity of corrosion. The rust condition may be output as a score or a preset identifier. In addition, the application may indicate whether the rust can be treated or whether an object needs to be replaced.

The assessment provided in the method 300 may be used as part of an end-to-end claims process. For instance, in some use cases, an insurance company may offer an initial settlement to the user based on the assessment performed in 325. This allows the user to receive compensation from the entity autonomously without a live employee reviewing or approving the monetary offer. However, the user may provide additional information at a later time if additional funds are needed. The additional information may be evaluated, and the assessment may be updated. In another use case, the entity may identify contractors that may fix the damage and/or perform the repairs identified in the assessment.

The application may generate an inspection report of the real property which includes insights generated from the AI, including an assessment of the overall condition of the real property (Excellent, Good, Fair, Poor, etc.). In addition, or alternatively, the inspection report might include the total estimated cost to repair the real property to a higher level of condition (e.g., to transform an overall condition of poor to good). Additionally, the report may include a selection of images derived from the image data which indicative of the overall condition of the real property. Optionally the inspection report might provide more detail regarding various portions of the real property in need of repair, including the proposed repair operations, and the components of the costs of the repair operations. The report may include images taken from the video which show images which the AI has determined most clearly display the identified damage.

The exemplary embodiments may also be used to track the history of the real property. For instance, a real-time inspection of the real property may be performed using the user device 100 at a first time. The application may output a signature indicating a state of the real property at a first time, e.g., an assessment performed by machine learning models on image data showing one or more objects. The signature may comprise information such as, but not limited to, type of damage present, location of damage, severity of damage, the paint condition, the surface condition, the state of the exterior, the state of the interior and the presence and severity of rust. The signature may be stored in a secured database such as a decentralized blockchain based database.

As new inspections are performed, the signature may be updated. For example, a real-time inspection of the real property may be performed using the user device 100 at a second time. The signature may be processed by one or more trained models to identify different types of preventative maintenance that may be performed on one or more objects. In addition, the signature may provide a transparent history of the real property that may be used to appraise the current value of the real property.

In some embodiments, the application may determine a value for an undamaged version of one or more objects shown in the image data. This determination may be based on one or more machine learning models, existing pricing gradations, a look up table stored at the user device 100 or the remote server 210 or any other appropriate resource. The application may reduce the value derived for the undamaged version one or more objects based on the assessment of the state of the real property to generate an estimated value. For instance, factors such as, but not limited to, the geographical location of the real property, the state of the exterior of a building, the state of the interior of the building, the paint condition, the surface condition and the presence and severity of damage.

Instead of or in addition to reducing the value of the undamaged object, the application may produce as estimate of the cost to fix one or more aspects of the one or more objects. This may also include an estimate as to how fixing one or more objects may improve the estimated valuation of the real property. To provide one general example, one or more machine learning models may identify that the paint on one or more objects is faded, appliances are not energy efficient, there is water damage in multiple interior locations and a fence surrounding the perimeter of the property has multiple damaged sections. The application may reduce the value derived for the undamaged version the real property to account for these issues identified from the image data and generate an estimated value (X). In addition, the application may estimate the cost (A) to fix the faded paint, the cost (B) to replace the appliances, the cost to fix the water damage (C) and the cost (D) to repair the damaged fence. The application may further estimate that fixing the faded paint may increase the estimated value (X) by a value (U), replacing the appliances may increase the estimated value (X) by a value of (V), repairing the water damage may increase the estimated value (X) by a value of (W) and repairing the damaged fence may increase the estimated value (X) by a value of (Z). The examples provided above are merely provided for illustrative purposes and are not intended to limit the exemplary embodiments in any way.

As mentioned above, the exemplary embodiments may allow a user to perform an inspection of real property in real-time using the user device 100. The user may collect image data using the camera 120 of the user device 100. The application may include one or more machine learning models for determining which objects have been captured in in the image data. The one or more machine learning models may be executed at the user device 100 while the user is taking photos and/or recording video. Thus, the application may provide a user interface that identifies what is currently being captured in the video and an overlay which is updated to track the user's progress and/or guide the user in collecting sufficient image data to perform the assessment of the real property. The dynamic feedback that may be provided to the user is described in more detail below.

FIG. 4 shows a method 400 for collecting image data to perform an inspection of real property using an AI based application to according to various exemplary embodiments. The method 400 is described with regard to the user device 100 of FIG. 1, the system 200 of FIG. 2 and the method 300 of FIG. 3.

The following description of the method 400 will provide an overview of how the application may process image data, interact with the user and generate an assessment of the state of the real property.

In 405, the user device 100 launches the application. For example, the user may select an icon for the application shown on the display 125 of the user device 100. After launch, the user may interact with the application via the user device 100. To provide a general example of a conventional interaction, the user may be presented with a graphical user interface that offers any of a variety of different interactive features. The user may select one of the features shown on the display 125 via user input entered at the display 125 of the user device 100. In response, the application may provide a new page that includes further information and/or interactive features. Accordingly, the user may move through the application by interacting with these features and/or transitioning between different application pages.

In 410, the application receives image data captured by the camera 120 of the user device 100. The application may request that the user capture image data of different objects of the real property. For example, the user may be prompted to record video of the exterior of a building, the interior of the building, a fence, a yard, crops, tree shrubs, equipment, etc. According to some exemplary embodiments, the method 400 may be a continuous process where one or more segments of video are provided downstream to the one or more machine learning models while the user is actively aiming the camera at an object to take a photo or during the recording of video. This may allow the application to provide dynamic feedback that guides the user in recording video of sufficient quality for performing the assessment of the real property.

In 415, the application determines whether the image data satisfies predetermined criteria. The predetermined criteria may be based on the image quality or video quality. In some embodiments, the predetermined criteria may be based on data collected from other components of the user device 100.

In one example, the application may identify that one or more images or one or more video segments that are blurry and lack sufficient clarity, have regions experiencing glare or have insufficient lighting. The exemplary embodiments may evaluate any appropriate type of quality metric associated with the images or video to determine whether the images or video lack sufficient clarity. The clarity may be affected by the manner in which the images or video are recorded. For instance, if the camera 120 moves in a particular manner when an image is captured or during the recording of the one or more segments of video, the content may become too blurry, and it may be difficult to identify the objects captured in the image data. In some embodiments, instead of or in addition to a quality metric, the predetermined criteria may be based on a speed parameter of the user device 100, an acceleration parameter of the user device 100 and/or any other appropriate type of movement-based parameter of the user device 100 exceeding a threshold value. This may include the application collecting data from other internal components of the user device 100 (e.g., accelerometer, gyroscope, motion sensor, etc.) to derive a parameter associated with the movement of the user device 100 while recording the one or more video segments and comparing the parameter to a threshold value. If the parameter exceeds the threshold value, the application may assume that the one or more segments of video are not of sufficient quality because they were not recorded in a manner that is likely to provide video data that may be used to assess the state of the real property.

In another example, the application may identify that an image or more video segment was recorded from a perspective that is too close to the object of interest, too far from the object or interest and/or at an inadequate camera angle. The exemplary embodiments may evaluate any appropriate type of quality metric associated with the images or video to determine whether the image data is recorded from an appropriate perspective (e.g., distance, angle, etc.). In some embodiments, instead of or in addition to a quality metric, the predetermined criteria may be based on a distance parameter and/or a camera angle parameter between the object of interest and the user device 100 during the recording of the one or more segments of video.

If the predetermined criteria are not satisfied, the method 400 continues to 420. In 420, the application may generate an alert to indicate to the user that the manner in which the image data is being recorded needs to be modified. For example, when the application identifies that the one or more video segments lack sufficient clarity, the alert may explicitly or implicitly indicate to the user that the camera is moving too fast, and the user should slow down and/or move the camera in a less erratic manner. In another example, when the application identifies that the one or more video segments were recorded from inadequate distance or angle, the alert may explicitly or implicitly indicate to the user that the camera is too close to the object of interest, too far from the object of interest or configured at an improper angle. The alerts may be a visual alert provided on the display 125 of the user device 100 and/or audio alert provided by an audio output device of the user device 100.

Returning to 415, if the image data does not satisfy the predetermined criteria, the method 400 continues to 425. In 425, the application identifies one or more objects shown in the image data. In 430, the application updates an overlay displayed at the user device 100. From the perspective of the user, the display 125 may show an interface that include the overlay and video data being captured by the camera 120. As will be described in more detail below, the overlay may be updated to indicate a position of the user device 100 relative to the object of interest during the recording of the image data, indicate an amount of image data collected and/or to be collected for the assessment of the state of the real property or provide any other type of information that may guide the user in recording the video needed to assess the state of the real property.

As mentioned above, the application may provide dynamic feedback to the user to aid the user in capturing image data that adequately captures the objects of interest and/or is of sufficient quality to assess the state of the real property. One example of dynamic feedback is the alert generated in 420. Another example of dynamic feedback is the dynamic overlay referenced in 430.

The dynamic feedback may indicate the need to move the camera closer or further from the areas of potential damage based on damage assessments performed using machine learning models. The information related to the need to move the camera closer or further can be based on information obtained from the user device 100 using a LIDAR sensor or any of the other sensors discussed above. The application could give a general indication that the camera should be moved closer, or further, or it could give a recommended distance from the area of interest. The application may also give recommendations, or request additional images be taken, from various angles, as discussed above, based on the damage assessments.

Additionally, the application may display information indicative of a need for a closer image or video of an area of interest. In some embodiments, the display may indicate areas of interest using a bounding box, cross-hair arrows or any other appropriate means on already acquired images or portions thereof. Once the area of interest has been captured, a visual, audio and/or haptic response may be used to indicate that the user may proceed further with capturing the image data as normal. Capturing image data of a region of interest may include images, videos or a combination thereof. The video or images may be captured at different resolutions or different compression methods than the other image data.

The application may request that the user capture image data of an object of interest from multiple different perspectives. For example, the application may request that one or more panoramic photos of the exterior of a house be taken to enable the number of unique objects to be tracked and counted (e.g., 315). In another example, the application may request that the user capture video of the exterior of the house while the user moves around the perimeter of the house to enable the number of unique objects to be counted (e.g., 315 of the method 300).

In some embodiments, the dynamic feedback may include a graphical indication that tracks the camera 120 position relative to the object of interest and a score indicating how much of the exterior of the object of interest has been captured in the image data. The score may be shown as a percentage or any other appropriate quantitative value.

In some embodiments, there may be a request that the user slow down while recording video or a panoramic photo. The alert may further explain that moving too fast may cause the image data to be blurry. In other embodiments, augmented reality (AR) techniques may be used to provide dynamic feedback that is more sophisticated than a two-dimensional graphic. The exemplary embodiments may utilize any appropriate graphic or visual component to provide the user with dynamic feedback that guides the user in recording video and/or collecting data to assess the state of the real property.

The application may also obtain data from the user device 100 regarding the height of the camera 120 during the recording of the video. Using a calculation of the height, the application may guide the user to increase or decrease the height of the camera 120 to capture additional information. As indicated above, the video may be analyzed to determine the distance of the camera 120 from the object of interest. Alternatively, this distance may be based on information obtained from a sensor such as, for example, a light detection and ranging (LIDAR) sensor embedded in the user device 100. Information from other types of sensors may also be used to determine the distance, such as ultrasonic, infrared, or LED time-of-flight (ToF). The application could also determine whether the angle of the video should be changed to improve the ability of the application to assess the state of the real property. The angle can be adjusted in the vertical plane and/or the horizontal plane to provide e.g., an image perpendicular to the object of interest, an image level with the midpoint of the height of the object of interest but not perpendicular to the side, or an image from an angle above the object of interest.

In 435, the application determines whether sufficient image data has been collected to assess the state of the real property. When more image data is needed to assess the state of the real property, the method 400 returns to 410 where one or more images or one or more segments of video are received by the application.

In some embodiments, the application may prompt the user to acquire additional video or images of certain objects based on conditions identified from the image data. For example, if damage is detected to an exterior wall of the house, the application may request that the user open collect image data from the interior portion of the house that aligns with the damaged exterior portion. In another example, if damage is identified that is consistent with a type of event, the application may request that the user take additional video of the other objects that may also be damaged by the same type of event.

When more image data is not needed to assess the state of the real property, the method 400 continues to 440. In 440, the application generates an assessment of the state of the real property. This may be similar to 325 of the method 300.

In a further embodiment, the one or more machine learning models may generate a confidence value associated with the assessment of the real property. The system may identify objects for which the assessment has a confidence level below a certain level and prompt the user to record additional video of that object. The dynamic display could indicate what objects currently seen by the camera 120 have an adequate level of confidence. The dynamic display could further indicate which objects have damage assessments with a predetermined level of confidence in images captured earlier in that session. This will enable the user to isolate which objects need to be captured to assess the state of the real property.

In some embodiments, the application may restrict the manner in which the video of the real property is recorded by the user to ensure that the objects shown in image data are associated with the same real property. For example, the application may require the user to capture an image or a video that shows the entirety of a portion of an object of interest. This may act as a security feature and ensure that the image data includes multiple objects in the same image or video such that the unique objects shown in the image data may be countered and tracked. In another example, the application may request a continuous video that includes an identifier specific to the object of interest (e.g., address, front door, mailbox, etc.). This may ensure that the video has not been edited in a manner that may alter the assessment of the real property. In another example, if multiple video clips are used, the application may require that each video clip shows a same object. In addition, the application may compare an object's color, dimensions and/or materials in a first video clip to an object's color, dimensions and/or materials in a second video clip to ensure that the object shown in the first and second video clip are the same object.

In some embodiments, the AI system will be used to create floor plans of the interior of a structure, in 2 or 3 dimensions. This can be done by the AI system analyzing the images, or alternatively by requesting a user to identify the corners of a room. The distance measurements can be made by any of the methods described earlier. The creation of this 2D or 3D model can be made using the visual information obtained from a user device, augmented with aerial, satellite or drone images. Additionally, it may optionally be augmented based on other information such as engineering drawings, floor plans, and other information previously stored regarding the real property.

The AI system can determine the identity of objects using machine learning models and other methods described earlier. Similarly, it can use techniques such as GPS, triangulation methods from images, triangulations using accelerometers, to determine the location of these objects, including optional their boundaries, which can be recorded and optionally identified with respect to the 2D or 3D model of the interior or exterior of the real property.

Among the information that can be identified using the machine learning models for these objects includes identification of components of an object, the materials of an object, the design of the object, the type of object, and the objects dimensions. The machine learning models can also be used to identify whether an object is damaged, the type of damage (e.g., water damage, cracks, dents, warps, and other classifications of damage relevant to the object), a determination of the relevant repair operations or mitigation efforts needed.

The AI system may include machine learning models that identify types of damage that may make a building uninhabitable or unsafe, and may provide that information to the user. Additionally, the AI system may include models that are able to identify the presence of dangerous objects in the property, such as the possible presence of certain types of mold, and alert the user to those concerns as well.

The AI system can be configured to create an overall report of the real property and the associated objects, which can include some or all of the information identified by the AI system, and may also include the evidence related to that aspect of the report, such as still images relevant to a damage determination, videos relevant to a determination, audio information related to the determination, and/or other information discussed above such as moisture of an object or an infrared image of a location. This report may be either a single document, an interactive computer report, an augmented reality or virtual reality tour, or any other method for communicating information to either the user or a remote party (such as an insurance company, repair company, etc.).

This report may include recommendations for immediate action, and recommendations of actions that may take place later. The immediate action items can be determined based on damage that if not corrected promptly may lead to additional damage, or steps that may need to be taken promptly for safety purposes. The report may also identify materials needed for the actions, such as dehumidifiers or fans to reduce moisture, personal protection equipment in the event of toxic molds, etc. Among the actions identified may be both temporary and permanent actions. For example, the system may identify that there is a hole in the roof and instruct that a plastic tarp be placed over the hole until a repair can be made. These actions may be further prioritized and identified based on predictions of local weather. For example, if a rainstorm is coming, then the temporary covering of openings in a structure will be prioritized.

This report can be provided to a user such as a home owner or repair technician for review and to determine agreement with the AI system's assessment. In instances where there is an error in the AI system's determinations, the user can identify a disagreement, and the AI system may request additional information to be gathered regarding the determination.

Through the use of AR, or other visual means, the AI system can provide real-time assessments of any of the items discussed above. For example, it could identify a lamp, moisture damage, a hole in a roof, a damaged fence, an undamaged door. The AI system can allow a user to identify any disagreements with the AI system's determinations in real time as well, allowing for immediate gathering of other relevant information.

The AI system can request that the user identify structures, objects, components, or areas of damaged on a display by circling, highlighting, or selecting the component. This can be done, for example, through use of an AR or VR display. Additionally, the system may request that the user identify areas where they notice smells, humidity, airflow, that may not be readily apparent to the user device 100. This may be referred to as the user identifying a region of interest in the 2D or 3D model that was constructed for the real property.

Prior to information leaving a user device to be delivered to other components of the AI system, the AI system can cause the device to remove certain categories of personally identifiable information (such as faces of individuals), or information indicative or religious or political leanings. This can be done for a number of reasons, including a desire to avoid bias in the coverage of insurance claims for improper reasons.

Additional verifications of the accuracy of the information gathered can be performed such as, comparison of pre-existing images of a structure, including from Google Street Views, satellite images, or images being collected for a given address. Additionally, information on the location from governmental files, such as property databases, can be compared to the information gathered to confirm that the real property is the same as recorded to be at the location. This can be done to avoid simple human error or cases of fraud. Additional, geolocation data can be captured for the various images, videos and other data collected, to confirm in the case of multiple sessions that all of the data collected is from the same location. Additionally, images can be compared with images collected by an insurance company at an earlier date of time, such as at the beginning of coverage, in relation to earlier claims, or taken at the time of structural alterations to the real property.

The application may also be configured to request image data from the user prior to a predicted event. For example, weather information may be used to predict the occurrence of an event that may cause damage to the user's real property. The application may request that the user collect image data prior to the occurrence of the event to provide reference image data that may compared to image data captured after the occurrence of the event. In some exemplary embodiments, image data may be obtained prior to a weather event based on satellite, aerial, drone, or ground-based images acquired from third party sources

In another embodiment, the application may autonomously request that image data be taken by the user after the occurrence of an event. For instance, the application may utilize weather information to predict the occurrence of an event that may cause damage to the user's real property. In addition, the application may determine whether any policy holders are within the vicinity of the event and/or whether any policy holders own real property that possess characteristics that are susceptible to damage that may be caused by the type of event. The application may autonomously send a notification to user's that satisfy this criteria to collect image data since it is likely that damage has occurred to the user's real property.

In some exemplary embodiments, AI and/or machine learning (ML) techniques may be used to create classifiers and models that can predict likely damage to structures from near future weather events. The information used by the classifier or models to predict the damage may include satellite images (including doppler radar, infrared, visible), expected wind speeds and directions, storm surges, tides, and other weather related data of incoming hurricanes, typhoons, tropical storms expected to hit a region over a period of the coming hours to days. These classifiers and models may be trained based on historical weather data and damage to structures, and information regarding the structures such as type of construction, materials used in construction, location of nearby objects such as trees, rivers, coastlines, and age of structure. The classifiers and models can then be used to predict damage to structures from impending weather events based on this same type of data (the weather data and information regarding the structures). Similar classifiers and models can be trained based on historical information regarding structures, and local objects and flooding due to various events that will impact local water levels, to predict damage due to potential near-term flooding.

These weather related classifiers and models can also be used to evaluate existing real property and structures to determine if there are steps that can be taken to reduce their potential damage from future weather events. For example, the application could model the possible damages for potential future weather events (based on historical likelihoods and trends) based on the current characteristics of the structure, and then evaluate the possible damages based on alterations to the structure (such as changing the roof materials, changing fencing type, removal of trees, addition of trees or windbreaks, shoring of riversides). The expected costs for making the alterations can be also computed. Based on this information, recommendations may be made based on comparisons of expected reductions in costs of damage to the expected cost of making the alterations. Additionally, the information could be provided to the homeowner to allow them to determine a course of action taking into account any other considerations (such as the value of not being displaced due to storm damage.

The determination of the impact of a weather event can be made not just for one structure, but for all or a subset of structures in a region. Based on this information the relevant entities could make preparations. For example, insurance companies could utilize the potential damages for its internal purposes. Construction companies and building supply companies could anticipate the need for certain materials and make necessary preparations to get the materials to the region in a safe and timely manner.

Additionally, these predictions regarding the impact to a region based on the individual structures in the region could be used by governmental agencies, aid or relief organizations, or other institutions to determine the likely impact of a weather event (whether an impending event, or a statistical analysis of likely events), and use this information to plan for future weather disasters. This planning could include a combination of pre-impact evacuations, planning for temporary housing, or providing for the post-impact repair and reconstruction efforts. The region evaluated can be of any size, from several localized structures, to a village, town, city, zip code, county, province, state or national level. The number of structures evaluated could be under 10, less than a hundred, less than a thousand, less than ten thousand, less than a hundred thousand, or millions of structures (if not more). By doing this evaluation of the impact of weather events based on the actual structures in the region, the accuracy of planning could be greatly improved.

The modelling may be based on a statistical sampling of typical structures and their characteristics in a region where data of each structure is not available. The structures evaluated are not limited to housing or other structures discussed above, but could also include infrastructure, such as roads, bridges, railroads, dams, power plants, water treatment facilities, warehouses, airports, and harbors. Additionally, this evaluation could include the evaluation of alterations or modifications to the structures, as discussed above, but done on a larger scale of multiple structures. This could aid any of the above mentioned entities determine pro-active and reactive approaches to weather events, such as flooding, hurricanes, tornadoes, tropical storms, droughts, etc.

Those skilled in the art will understand that the above-described exemplary embodiments may be implemented in any suitable software or hardware configuration or combination thereof. An exemplary hardware platform for implementing the exemplary embodiments may include, for example, an Intel based platform with compatible operating system, a Windows OS, a Mac platform and MAC OS, a mobile device having an operating system such as iOS, Android, etc. The exemplary embodiments of the above-described methods may be embodied as software containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method, comprising:
receiving image data;
identifying, using a first set of one or more machine learning models, multiple objects related to real property that are shown in the image data;
determining a number of unique objects that are shown in the image data; and
generating, using a second set of one or more machine learning models, an assessment of a state of the real property.

2. The method of claim 1, wherein the first set of one or more machine learning models and the second set of one or more machine learning models are a same set of one or more machine learning models.

3. The method of claim 1, wherein generating the assessment of the state of the real property further comprises:
determining a damage state for at least one unique object.

4. The method of claim 3, wherein the damage state includes at least one of a location of damage or a severity of damage.

5. The method of claim 3, wherein the damage state includes at least one of an estimated repair cost, a repair methodology and an estimated number of labor hours to perform a repair.

6. The method of claim 1, wherein generating the assessment of the state of the real property further comprises:
determining physical dimensions for at least one unique object.

7. The method of claim 1, wherein generating the assessment of the state of the real property further comprises:
determining one or more materials for at least one unique object.

8. The method of claim 1, wherein the image data includes at least one of satellite images, images captured by a drone or images captured during an aerial fly over of the real property.

9. The method of claim 1, further comprising:
generating feedback that is to be displayed at a user device, wherein the user device captured at least a portion of the image data and wherein the feedback is provided in an interface comprising the feedback and a view of a camera of the user device.

10. The method of claim 9, wherein the feedback includes an alert configured to indicate a request to a user to change a distance or angle between the camera and the real property.

11. The method of claim 10, wherein the request to change the distance or the angle is based on a presence of an object of interest, a region of interest relative to one or more objects or a region of damage relative to one or more objects.

12. The method of claim 9, wherein the feedback includes an alert configured to indicate a request to a user during recording of video to change a manner in which the user is moving the camera.

13. The method of claim 1, further comprising:
receiving predicted weather related data; and
determining, using a third set of one or more machine learning models, predicted weather related damage for the real property.

14. The method of claim 1, further comprising:
constructing, based on at least the image data, a two-dimensional (2D) or three-dimensional (3D) model of the real property.

15. The method of claim 14, wherein the 2D model or 3D model are constructed using augmented reality (AR) or virtual reality (VR) techniques.

16. The method of claim 14, further comprising:
requesting feedback related to the 2D model or 3D model from a user, wherein the feedback is related to identifying a region of interest in the 2D model or 3D model.

17. The method of claim 1, further comprising:
receiving feedback from a user related to the assessment of the state of the real property.

18. The method of claim 1, further comprising:
receiving non-image data related to the real property, wherein the assessment of the state of the real property is. Generated based on the non-image data.

19. The method of claim 1, further comprising:
segmenting the image data to identify one or more of the multiple objects or an object occluding the one or more of the multiple objects.

20. The method of claim 1, further comprising:
verifying an accuracy of the image data based on images received from a third party source.
